(19) United States
(12) Patent Application Publication
(10) Pub. No.: US 2017/0177899 A1
(43) Pub. Date: Jun. 22, 2017

(54) ENCRYPTED DATA DEDUPLICATION IN CLOUD STORAGE

(71) Applicant: Agency for Science, Technology and Research, Singapore (SG)

(72) Inventors: Yibin Ng, Singapore (SG); Shuqin Ren, Singapore (SG); Mi Mi Aung Khin, Singapore (SG)

(21) Appl. No.: 15/379,839

(22) Filed: Dec. 15, 2016

(30) Foreign Application Priority Data
Dec. 17, 2015 (SG) 10201510394R

(51) Int. Cl. G06F 21/62; G06F 3/06; H04L 9/32; H04L 9/00; H04L 9/06

(52) U.S. Cl. CPC G06F 21/6227; H04L 9/008; H04L 9/0643; H04L 9/3236; G06F 3/0608; G06F 3/062; G06F 3/0641; G06F 3/0643; G06F 3/067; G06F 2221/2107

(57) ABSTRACT

There is provided a method of storing data in a cloud storage system, the method including: generating a file identifier for a data file desired to be stored in the cloud storage system; encrypting the file identifier of the data file using a homomorphic encryption technique to produce an encrypted file identifier of the data file; and transmitting the encrypted file identifier to the cloud storage system for performing data deduplication in relation to the cloud storage system with respect to the data file. There is also provided an associated client device and cloud storage system.

### CROSS-REFERENCE TO RELATED APPLICATION

This application claims the benefit of priority of Singapore Patent Application No. 10201510394R, filed 17 Dec. 2015, the contents of which being hereby incorporated by reference in its entirety for all purposes.

### TECHNICAL FIELD

The present invention generally relates to encrypted data deduplication in cloud storage, and more particularly, to a method of storing data in a cloud storage system, and associated client device and cloud storage system.

### BACKGROUND

Deduplication has been widely recognized as an essential method to save storage costs for cloud-based storage providers such as Dropbox and Google Drive. Conventionally, to perform deduplication, the cloud storage provider (CSP) (i.e., the cloud storage system, such as, managed by CSP) needs to detect that a duplicate data file (or simply referred to as “file”) has been uploaded to the CSP and to save space by storing only a single copy of the data file in the CSP. This saving on storage space can then result in saving on storage resources and costs, leading to substantial economic benefits.

However, clients may wish to have their files encrypted prior to storing on the CSP due to privacy reasons or company regulations. Conventional encryption schemes/techniques (non-convergent encryption based techniques) are not helpful in this regard because such techniques result in randomized ciphertexts. That is, for the same underlying plaintext, different users will encrypt it to different ciphertexts. As such, based on such conventional encryption techniques, the CSP will not be able to perform deduplication. In view of this, convergent encryption (CE) based schemes/techniques have been proposed. In CE, a key K is derived as a hash of a message/file M, i.e., K←H(M), where H(Ψ) denotes a cryptographic hash function. Subsequently, the encrypted file C is obtained as C←E(K,M), where E(•) denotes a deterministic symmetric encryption scheme. The same message/file M will produce the same key K and subsequently the same encrypted file C, thus enabling deduplication. Another benefit of generating keys based on message M is that it does not introduce a key-sharing problem across various users with the same message M Further, an attacker that does not know message M cannot generate the key K and therefore cannot obtain the plaintext M from the ciphertext C. However, this scheme is susceptible to brute-force attacks on message M. For example, if message M is predictable, an attacker is able to derive key K and subsequently message M In this regard, in practice, various messages are predictable. For example, short messages or messages with known headers. This thus raises security concerns for the conventional CE scheme.

Several key server techniques/schemes have been proposed to improve on the CE scheme, for example, the homomorphic encryption deduplication (HEDup) scheme and the duplicateless encryption for simple storage (DupLESS) scheme. Both HEDup and DupLESS improve on the conventional CE scheme by employing the use of a key server (KS). For DupLESS, the KS generates and assigns a message-derived key to the client for the encryption of a message M Furthermore, to combat against brute-force attacks of the message M by an attacker, rate-limiting measures are employed on the KS. DupLESS achieves semantic security. However, the present inventor(s) notes that DupLESS suffers from several drawbacks, including leakage of file length, equality of the underlying plaintexts, and access patterns. The present inventor(s) also notes that a further problem of DupLESS and HEDup is that regardless of whether the same file already exists in the CSP or not, the entire encrypted file is nevertheless sent over to the CSP. It is then left to the CSP to perform deduplication within the CSP for identical/duplicate files in an offline manner/process.

A need therefore exists to provide encrypted data deduplication in cloud storage that seeks to overcome, or at least ameliorate, one or more of the deficiencies of conventional encrypted data deduplication techniques such as the techniques as mentioned above. It is against this background that the present invention has been developed.

### SUMMARY

According to a first aspect of the present invention, there is provided a method of storing data in a cloud storage system, the method comprising:
generating a file identifier for a data file desired to be stored in the cloud storage system;
encrypting the file identifier of the data file using a homomorphic encryption technique to produce an encrypted file identifier of the data file; and
transmitting the encrypted file identifier to the cloud storage system for performing data deduplication in relation to the cloud storage system with respect to the data file.

In various embodiments, the file identifier is generated based on a hash function of the data file such that the file identifier generated is unique to the data file.

In various embodiments, the method further comprises encrypting the data file based on a key generated by a key server to produce an encrypted data file, wherein the file identifier is generated based on the encrypted data file.

In various embodiments, performing data deduplication comprises:
determining whether a stored data file exists in the cloud storage system that is a duplicate of the data file desired to be stored in the cloud storage system based on the encrypted file identifier of the data file; and
determining whether to transmit the data file to the cloud storage system for storage therein based on whether said stored data file is determined to exist in the cloud storage system.

In various embodiments,
encrypting the file identifier comprises encrypting each bit of the file identifier using the homomorphic encryption technique to obtain the encrypted file identifier comprising a plurality of cipertexts; and
determining whether the stored data file exists in the cloud storage system that is a duplicate of the data file desired to be stored in the cloud storage system comprises:
   comparing the encrypted file identifier with a file identifier stored in the cloud storage system to obtain a result, the file identifier stored in the cloud storage system corresponding to a data file stored in the cloud storage system;
   decrypting each bit of the result to obtain a decrypted result; and
   determining that the stored data file exists in the cloud storage system if each bit of the decrypted result is of a predetermined value.

In various embodiments, said comparing the encrypted file identifier compares the encrypted file identifier with each file identifier stored in the cloud storage system, respectively, to obtain a respective result.

In various embodiments,
said encrypting the file identifier is performed at a client device instructed to store the data file in the cloud storage system;
said comparing the encrypted file identifier is performed at the cloud storage system;
said decrypting each bit of the result is performed at the client device; and
said determining that the stored data file exists in the cloud storage system is performed at the client device.

In various embodiments, said comparing the encrypted file identifier comprises computing a difference between the encrypted file identifier and said file identifier stored in the cloud storage system, said file identifier stored in the cloud storage system being encrypted.

In various embodiments,
encrypting the file identifier comprises encrypting each bit of the file identifier using the homomorphic encryption technique to obtain the encrypted file identifier comprising a plurality of cipertexts; and
determining whether the stored data file exists in the cloud storage system that is a duplicate of the data file desired to be stored in the cloud storage system comprises:
   computing a function based on the encrypted file identifier and a file identifier stored in the cloud storage system to obtain a result, the file identifier stored in the cloud storage system corresponding to a data file stored in the cloud storage system;
   decrypting the result to obtain a decrypted result; and
   determining whether the stored data file exists in the cloud storage system based on whether the decrypted result is of a predetermined value.

In various embodiments, the function is configured such that the decrypted result will be the predetermined value if and only if each bit of the encrypted file identifier matches with each corresponding bit of said file identifier stored in the cloud storage system.

In various embodiments, the function is:

$${D}_{i , n} = {\prod }_{j = 0}^{J - 1} ( 1 + {C}_{ij} + {C}_{nj} )$$

wherein:
D_{i,n} denotes the result obtained for the encrypted file identifier of the i-th data file desired to be stored in the cloud storage system and the n-th file identifier stored in the cloud storage system;
Cᵢⱼ denotes the j-th bit of the encrypted file identifier of the i-th data file;
Cₙⱼ denotes the j-th bit of the n-th file identifier stored in the cloud storage system; and
J denotes a window size based on the number of bits of the encrypted file identifier of the i-th data file.

In various embodiments, the window size of the function is determined based on a security parameter associated with the homomorphic encryption technique.

In various embodiments,
said encrypting the file identifier is performed at a client device instructed to store the data file desired in the cloud storage system;
said computing a function is performed at the cloud storage system;
said decrypting the result is performed at the client device; and
said determining that the stored data file exists in the cloud storage system is performed at the client device.

In various embodiments,
encrypting the file identifier comprises encrypting the file identifier using the homomorphic encryption technique to obtain a cipertext constituting the encrypted file identifier; and
determining whether the stored data file exists in the in the cloud storage system that is a duplicate of the data file desired to be stored in the cloud storage system comprises:
   comparing the encrypted file identifier with a file identifier stored in the cloud storage system to obtain a result, the file identifier stored in the cloud storage system corresponding to a data file stored in the cloud storage system;
   decrypting the result to obtain a decrypted result; and
   determining that the stored data file exists in the cloud storage system if the decrypted result is of a predetermined value.

In various embodiments, said comparing the encrypted file identifier compares the encrypted file identifier with each file identifier stored in the cloud storage system, respectively, to obtain a respective result.

In various embodiments,
said encrypting the file identifier is performed at a client device instructed to store the data file in the cloud storage system;
said comparing the encrypted file identifier is performed at the cloud storage system;
said decrypting each bit of the result is performed at the client device; and
said determining that the stored data file exists in the cloud storage system is performed at the client device.

In various embodiments, said comparing the encrypted file identifier comprises computing a difference between the encrypted file identifier and said file identifier stored in the cloud storage system, said file identifier stored in the cloud storage system being encrypted.

In various embodiments, the homomorphic encryption technique is a somewhat homomorphic encryption technique.

According to a second aspect of the present invention, there is provided a client device comprising:
a file identifier generation module configured to generate a file identifier for a data file desired to be stored in a cloud storage system;
an encryption module configured to encrypt the file identifier of the data file using a homomorphic encryption technique to produce an encrypted file identifier of the data file; and
a transmitter for transmitting the encrypted file identifier to the cloud storage system for performing data deduplication in relation to the cloud storage system with respect to the data file.

In various embodiments, the homomorphic encryption technique is a somewhat homomorphic encryption technique.

According to a third aspect of the present invention, there is provided a cloud storage system comprising:
a receiver for receiving an encrypted file identifier from a client device for a data file desired to be stored in the cloud storage system; and
a data deduplication module configured to compare the encrypted file identifier with a file identifier stored in the cloud storage system to obtain a result, or to compute a function based on the encrypted file identifier and a file identifier stored in the cloud storage system to obtain a result, for performing data.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a flow diagram illustrating a method of storing data in a cloud storage system according to various embodiments of the present invention;

FIG. 2 depicts an example environment or architecture in which the encrypted data deduplication in cloud storage according to various embodiments of the present invention may be implemented;

FIG. 3 depicts a schematic drawing of an exemplary computer system;

FIG. 4 depicts a schematic drawing illustrating the conventional DupLESS technique for a data upload;

FIG. 5 depicts a flow diagram illustrating a method of storing or uploading data in a cloud storage system by a user according to an example embodiment of the present invention;

FIGS. 6A and 6B depict flow diagrams showing a summary of an exemplary implementation of a data deduplication technique according to an embodiment of the present invention for the first upload of a file by a first client device and a subsequent upload of a file by a second client device, respectively;

FIG. 7 depicts a plot showing the performance results in uploading a file for the first time using the example KS_SWHE_LargeMsg technique according to an embodiment of the present invention and the conventional KS (baseline) technique;

FIG. 8 depicts a plot showing the throughput results in uploading a file for the first time using the example KS_SWHE_LargeMsg technique and the conventional KS (baseline) technique;

FIG. 9 depicts a plot showing the results in uploading a file for the i^{th} time, where i≧2, using the example KS_SWHE_LargeMsg technique and the conventional KS (baseline) technique; and

FIG. 10 depicts a plot showing the throughput results in uploading a file for the i^{th} time, where i≧2, using the example KS_SWHE_LargeMsg technique and the conventional KS (baseline) technique.

### DETAILED DESCRIPTION

Embodiments of the present invention provide encrypted data deduplication in cloud storage that seeks to overcome, or at least ameliorate, one or more of the deficiencies of conventional encrypted data deduplication techniques such as the techniques as mentioned in the background, and more particularly, to a method of storing data in a cloud storage system, and associated client device and cloud storage system.

As mentioned in the background, deduplication has been widely recognized as an essential method to save storage space for cloud storage providers (CSPs) (i.e., cloud storage systems, such as, managed by CSPs). According to various embodiments of the present invention, a homomorphic encryption technique, and preferably, a somewhat homomorphic encryption (SWHE) over the integers scheme/technique is employed to enable deduplication, as well as to secure the data desired to be stored in the cloud storage system against plaintext equality and access pattern leakage. For example, such an approach has advantages over conventional deterministic encryption schemes, which are commonly used to enable deduplication with privacy protection. In deterministic encryption schemes, the same ciphertext is always generated for the same plaintext. However, as mentioned in the background, this suffers from drawbacks of leaking information on equality of the underlying plaintexts/messages, access patterns of users, as well as the file length of the underlying plaintexts. As such, although data is stored securely in the cloud storage, information may still be leaked to an attacker observing the traffic during the data upload and retrieval process.

According to embodiments of the present invention, to address or remove such information leakages, it is recognised that after a data file (or simply referred to as “file”) is uploaded to the cloud storage system for the first time, for subsequent request(s) to upload the same file(s) to the cloud storage system, it is not necessary to upload the same file(s) to the cloud storage system and then rely on the cloud storage system to perform data deduplication (of which may be referred to as an offline process). In contrast, according to embodiments of the present invention, to perform data deduplication in relation to the cloud storage system, a file identifier of the file (the file identifier being unique to the file, that is, uniquely identifies or uniquely associated with the file) desired to be stored in the cloud storage system is sent to the cloud storage system to query if the same file already exists in the cloud storage system, and then only upload the file to the cloud storage system if it is determined that the same file does not exist in the cloud storage system (of which may be referred to as an online process, i.e., based on interactions/communications between the client device and the cloud storage system)). This approach advantageously provides benefits such as network traffic reduction. Further, from the file identifier alone, an attacker is unable to learn anything about the plaintext or message, the access patterns or the file length of the plaintext. As will be shown later below through experiments conducted according to example embodiments of the present invention, at least for larger file sizes, significant time savings can be obtained based on such an approach, and at the same time providing improved security.

According to embodiments of the present invention, the file identifier is protected using a homomorphic encryption technique, and preferably, a somewhat homomorphic encryption (SWHE) over the integers technique. Fully homomorphic encryption (FHE) is a method to perform unlimited computations on encrypted ciphertexts. Given ciphertexts c₁, c₂, . . . cₜ that represent individual encryptions of m₁, m₂, . . . , mₜ respectively under some key, and given a function ƒ(•), FHE allows one to compute an encryption of ƒ(m₁, m₂, . . . mₜ) without decryption. SWHE offers almost the same functionality as the FHE scheme, except that only a limited number of computations can be performed on the ciphertexts, beyond which the decryption result will become erroneous or incorrect. Therefore, according to embodiments of the present invention, for SWHE to decrypt correctly, the number of computations on encrypted ciphertexts is kept within a specified constant/value, of which may be computed and determined prior to usage (employing the SWHE technique). In this regard, the above-mentioned data deduplication in relation to the cloud storage system involving the querying process to determine if the same file already exists in the cloud storage system requires computations on the encrypted file identifier (encrypted ciphertext(s)). Further embodiments of the present invention analyse/determine the maximum number of ciphertexts that can be computed while ensuring decryption correctness. This aids in improving the efficiency of the encrypted data deduplication in cloud storage and reducing latency for the user during the file uploading process. Through the encrypted data deduplication technique according to embodiments of the present invention, a client device may be able to achieve significant throughput improvement over conventional encrypted data deduplication techniques, such as during the file uploading process.

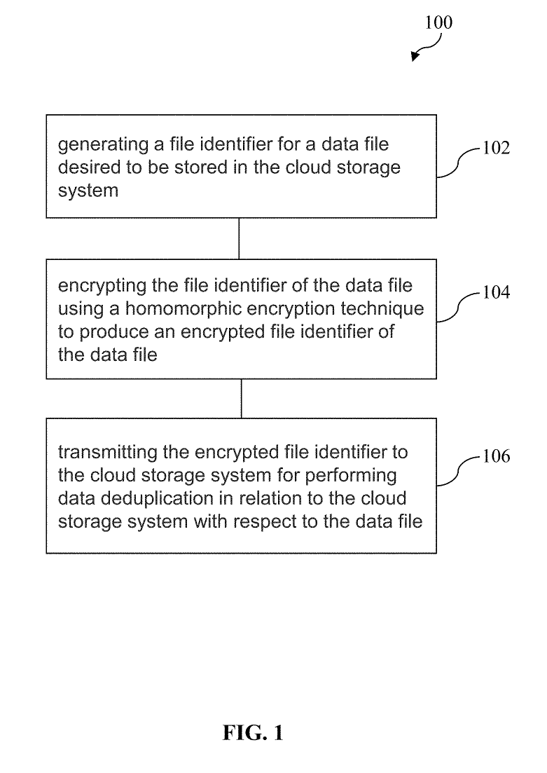

FIG. 1 depicts a flow diagram illustrating a method 100 of storing data in a cloud storage system according to various embodiments of the present invention. The method 100 comprises a step 102 of generating a file identifier for a data file desired to be stored in the cloud storage system, a step 104 of encrypting the file identifier of the data file using a homomorphic encryption technique to produce an encrypted file identifier of the data file, and a step 106 of transmitting the encrypted file identifier to the cloud storage system for performing data deduplication in relation to the cloud storage system with respect to the data file. As described above, generating and utilizing a file identifier of the file desired to be stored in the cloud storage system to perform data deduplication (to query if the same file already exists in the cloud storage system) rather than uploading the actual file desired to be stored in the cloud storage system and then subsequently performing data deduplication as performed in conventional techniques advantageously provides benefits such as network traffic reductions by avoiding the transmission/upload of the actual file in the case where the same file already exists in the cloud storage system. Furthermore, by utilizing the file identifier alone and encrypting the file identifier using a homomorphic encryption technique prior to being transmitted to the cloud storage system to query, a potential attacker is generally unable to learn about the plaintext or message, the access patterns or the file length of the plaintext, thus significantly enhancing data security.

In various embodiments, the file identifier is generated based on a hash function of the data file such that the file identifier generated is unique to the data file (i.e., uniquely identifies or uniquely associated with the data file). For example and without limitation, the hash function may be a collision-resistance hash function.

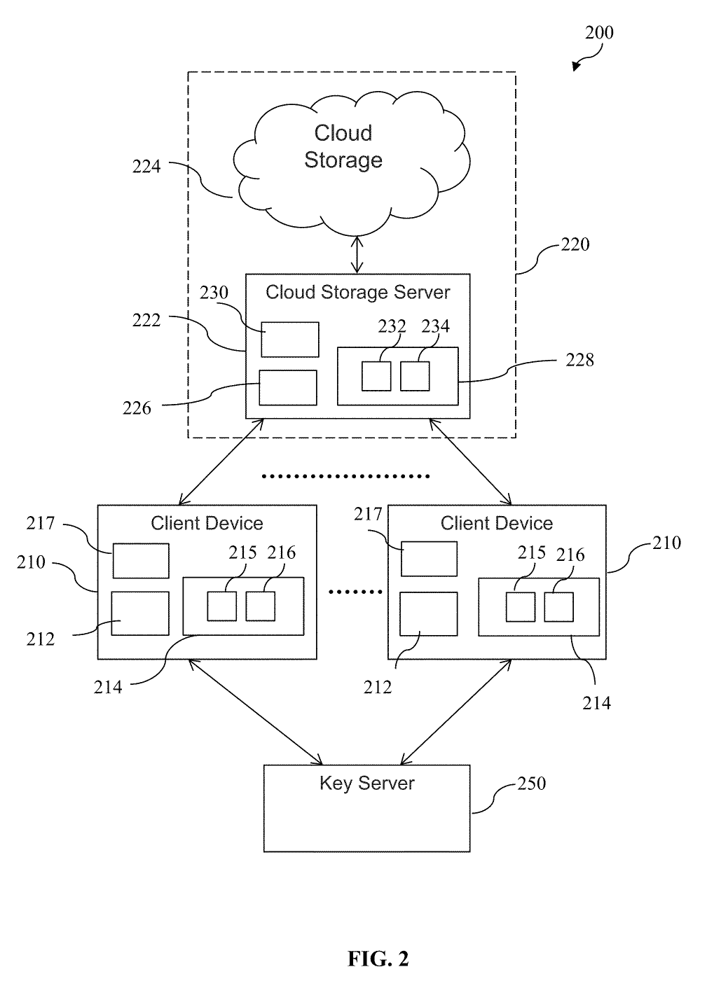

In various embodiments, upon receiving a request or an instruction to store or upload a data file to the cloud storage system (i.e., data file desired to be stored in the cloud storage system), the data file is first encrypted based on a key generated by a key server (e.g., 250 shown in FIG. 2 to be described below) to produce an encrypted data file. The file identifier is then generated based on the encrypted data file. By way of an example only and without limitation, the key server for generating a key (message-derived key) as described in Bellare et al., “DupLESS: Server-aided encryption for deduplicated storage,” USENIX Security Symposium, 2013, the contents thereof being hereby incorporated by reference in its entirety for all purposes, may be employed to generate the key to produce the encrypted data file as described herein. It will be appreciated that the key server is not limited to the key server as disclosed in Bellare et al., and various key servers configured to generate a key (generated based on the message or data file) for encrypting the message or data file known in the art may be utilized as appropriate or desired.

In various embodiments, performing data deduplication comprises determining whether a stored data file exists in the cloud storage system that is a duplicate of (the same as) the data file desired to be stored in the cloud storage system based on the encrypted file identifier of the data file, and determining whether to transmit the data file to the cloud storage system for storage therein based on whether the stored data file is determined to exist in the cloud storage system (that is, whether a data file that is the same as the data file desired to be stored in the cloud storage system is determined to already exist (already stored) in the cloud storage system).

FIG. 2 depicts an example environment or architecture 200 in which the encrypted data deduplication in cloud storage according to various embodiments of the present invention may be implemented. In the example environment 200, one or more client devices 210 may communicate with a cloud storage system 220 for one or more data files desired to be stored in the cloud data system 220. It will be appreciated that the client device 210 may be any electronic device comprising a processor 212 configured to execute computer executable instructions to perform one or more functions or methods, and a storage medium 214 communicatively coupled to the processor 212 having stored therein one or more set of computer executable instructions (modules) which are executable by the processor 212. For example, the client device 210 may include one or more files stored in the storage medium 214 desired to be uploaded to the cloud storage system 220. By way of examples only and without limitations, the client device 210 may be a desktop computer/computing system, a portable computer/computing system or a laptop, a mobile device such as a smart phone, a camera, a gaming device, or any other types of electronic device which may be requested/instructed to upload or store a data file in a cloud storage system 220. The cloud storage system 220 may comprise a cloud storage server 222 and a cloud storage 224. The cloud storage server 222 may act or operate as an interface through which the client device 210 may communicate with to store files in the cloud storage 224 and for handling or managing a cloud storage 224. It will be appreciated that the cloud storage 224 may comprise one or more networks of storage mediums or devices capable of storing data therein, and although only one cloud storage server 222 is shown in FIG. 2, the cloud storage system 220 may include multiple cloud storage servers 222, each cloud storage server 222 configured for handling or managing a corresponding network of storage devices in the cloud storage system 220. Typically, the cloud storage system 220 may be managed by a hosting entity or company (cloud storage providers). It will also be appreciated that the cloud storage server 222 may be realized by any computing system, such as a computer, comprising a processor 226 configured to execute computer executable instructions to perform one or more functions or methods, and a storage medium 228 communicatively coupled to the processor 226 having stored therein one or more set of computer executable instructions (modules) which are executable by the processor 226 (such as receiving and processing an input from the client device 210 to store data in the cloud storage 224 and perform data deduplication).

In various embodiments, as shown in FIG. 2, the client device 210 comprises a file identifier generation module or circuit 215 configured to generate a file identifier for a data file desired to be stored in a cloud storage system 220, an encryption module or circuit 216 configured to encrypt the file identifier of the data file using a homomorphic encryption technique to produce an encrypted file identifier of the data file, and a transmitter 217 for transmitting the encrypted file identifier to the cloud storage system 220 for performing data deduplication in relation to the cloud storage system 220 with respect to the data file. For example, the file identifier generation module 215 and the encryption module 216 may be stored in the storage medium 214 may each comprise computer executable instructions which are executable by the processor 212 to perform the respective functions. It will be appreciated that the transmitter 217 may be any communication interface (e.g., wireless or wired) capable of transmitting data from the client device 210 and may also be a transceiver.

In various embodiments, as shown in FIG. 2, the cloud storage system 220 comprises a receiver 230 for receiving an encrypted file identifier from a client device 210 for a data file desired to be stored in the cloud storage system 220 (the encrypted file identifier corresponding to the data file, that is, uniquely identifies or uniquely associated with the data file), and a data deduplication module or circuit 232 configured to compare the encrypted file identifier with a file identifier stored in the cloud storage system 220 to obtain a result, or to compute a function based on the encrypted file identifier and a file identifier stored in the cloud storage system 220 to obtain a result, for performing data deduplication with respect to the data file based on the result, whereby the file identifier stored in the cloud storage system corresponds to a data file stored in the cloud storage system 220. In various embodiments, the file identifier is encrypted and the cloud storage server 222 may comprise a database 234 of encrypted file identifiers, each encrypted file identifier uniquely corresponding to or uniquely identifying a data file stored in the cloud storage 224. For example, the data deduplication module 232 and the database 234 of encrypted file identifiers may be stored in the storage medium 228. The data deduplication module 232 may comprise computer executable instructions which are executable by the processor 212 to perform the above-mentioned function. It will be appreciated that the receiver 230 may be any communication interface (e.g., wireless or wired) capable of receiving data to the cloud storage server 222 and may also be a transceiver.

A computing system or a controller or a microcontroller or any other system providing a processing capability can be presented according to various embodiments in the present disclosure. Such a system can be taken to include a processor. For example, as mentioned above, the client device 210 and the cloud storage server 222 described herein each includes a processor/controller and a memory/storage medium which are for example used in various processing carried out therein as described herein. A memory or storage medium used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “computing”, “encrypting”, “decrypting”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms presented herein are not inherently related to any particular computer or other apparatus. Various general purpose machines may be used with programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated to a person skilled in the art that various modules described herein (e.g., file identifier generation module 215, encryption module 216, and/or data deduplication module 232) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of the computer program/module or method may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., file identifier generation module 215 and encryption module 216) executable by one or more computer processors to perform a method 100 of storing data in a cloud storage system as described hereinbefore with reference to FIG. 1 or other method(s) described herein. Accordingly, various computer programs or modules described herein may be stored in a computer program product receivable by a computer system or electronic device (e.g., client device 210 or cloud storage server 222) therein for execution by a processor of the computer system or electronic device to perform the respective functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

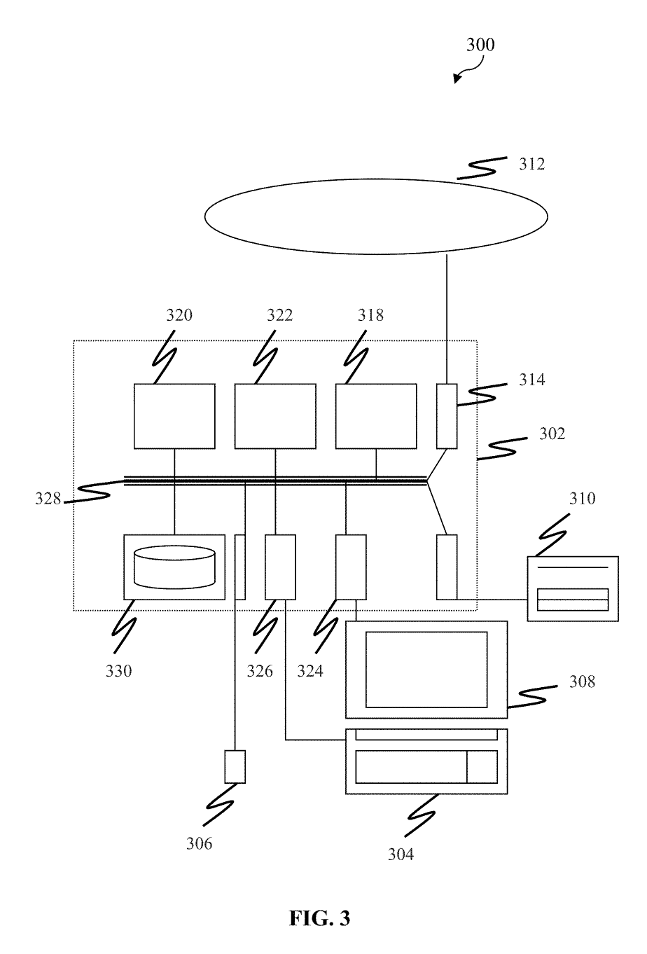

The methods or functional modules of the various example embodiments as described hereinbefore may be implemented on a computer system, such as a computer system 300 as schematically shown in FIG. 3 as an example only. The method or functional module may be implemented as software, such as a computer program being executed within the computer system 300, and instructing the computer system 300 to conduct the method of various example embodiments. The computer system 300 may comprise a computer module 302, input modules such as a keyboard 304 and mouse 306 and a plurality of output devices such as a display 308, and a printer 310. The computer module 302 may be connected to a computer network 312 via a suitable transceiver device 314, to enable access to e.g. the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present inventions will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

As described hereinbefore, according to embodiments of the present invention, the file identifier of the data file desired to be stored in the cloud storage system is encrypted using a homomorphic encryption technique for enhancing data security, such as addressing or removing the access pattern and plaintext equality leakage problem. In various example embodiments, the homomorphic encryption technique/scheme is a somewhat homomorphic encryption (SHWE) technique/scheme. By way of a background, the SWHE over the integers technique will now be briefly described or summarised below.

By denoting λ as the security parameter, and setting N=λ, P=λ², and Q=λ⁵. The SWHE technique may be described as including the following three algorithms:

KeyGen(λ): The secret key, denoted asp, is an odd integer chosen randomly from the interval [2^{P-1}, 2^{P});

Encrypt(p, m): To encrypt a bit mε{0, 1}, set c←pq+2r+m, where q is an integer chosen randomly from the interval [0, 2^{Q}), and r is an integer chosen randomly from the interval (−2^{N}, 2^{N}); and

Decrypt(p, c): Output (c mod p) mod 2, where (c mod p) is the integer c′ in (−p/2, p/2] such that p divides c-c′.

The term (c mod p) is commonly called the noise (noise term/factor) of the ciphertext c. For decryption to work correctly, it is important that the noise term is smaller than or equal to p/2 and greater than −p/2. If the noise term inflates to beyond the range (−p/2, p/2], the decryption may be incorrect.

The above technique is homomorphic because, for example, by simply adding, subtracting, or multiplying the ciphertexts as integers, the underlying messages or plaintexts are also added, subtracted, or multiplied. However, these operations will increase the noise of the ciphertext, and eventually, as the number of computations increase, the noise becomes too large and decryption does not return the correct result.

As an example, consider the subtraction operation below whereby c₁=pq₁+2r₁+m₁, and C₂=pq₂+2r₂+m₂, and c=C₁−c₂:

$$\begin{matrix}c = {c}_{1} - {c}_{2} \\ = {pq}_{1} + 2 {r}_{1} + {m}_{1} - {pq}_{2} - 2 {r}_{2} - {m}_{2} \\ = p ( {q}_{1} - {q}_{2} ) + 2 ( {r}_{1} - {r}_{2} ) + {m}_{1} - {m}_{2}\end{matrix}$$

From the above subtraction operation, it can be seen that the noise term of c is 2(r₁−r₂)+m₁−m₂. Therefore, as long as 2(r₁−r₂)+m₁+m₂ is within the range (−p/2, +p/2], the decryption procedure will work correctly, that is, (c mod p) mod 2=m₁−m₂ as it should be.

Various embodiments of the present invention are concerned with the subtraction and multiplication operations as such operations will be used in the data deduplication techniques described herein to determine whether a particular file already exists in the cloud storage system or cloud storage provider (CSP) or not. To obtain a fully homomorphic encryption (FHE) technique from a SWHE technique, a bootstrapping operation is required. The bootstrapping operation is one of the most computationally intensive operations in the FHE technique and significantly adds to the latency of the system. Accordingly, the data deduplication techniques according to various embodiments of the present invention are configured such that the bootstrapping operation is not required. As such, the data deduplication techniques are much simpler and more practical than FHE techniques, thus avoiding the severe complexity issues encountered by FHE techniques.

By way of an example only and without limitation, data deduplication techniques using SWHE according to various embodiments of the present invention will now be described as being incorporated/implemented into the conventional DupLESS technique (resulting in a modified DupLESS technique) such that the improvements over the conventional DupLESS technique can be better understood and shown. It will be appreciated that the data deduplication techniques using SWHE according to various embodiments of the present invention can be incorporated into various data deduplication techniques known in the art which use a key server (KS) for generating a unique message-derived key as appropriate/desired for various purposes without departing from the scope of the present invention.

By way of a background, the conventional DupLESS technique will now be briefly described or summarised below.

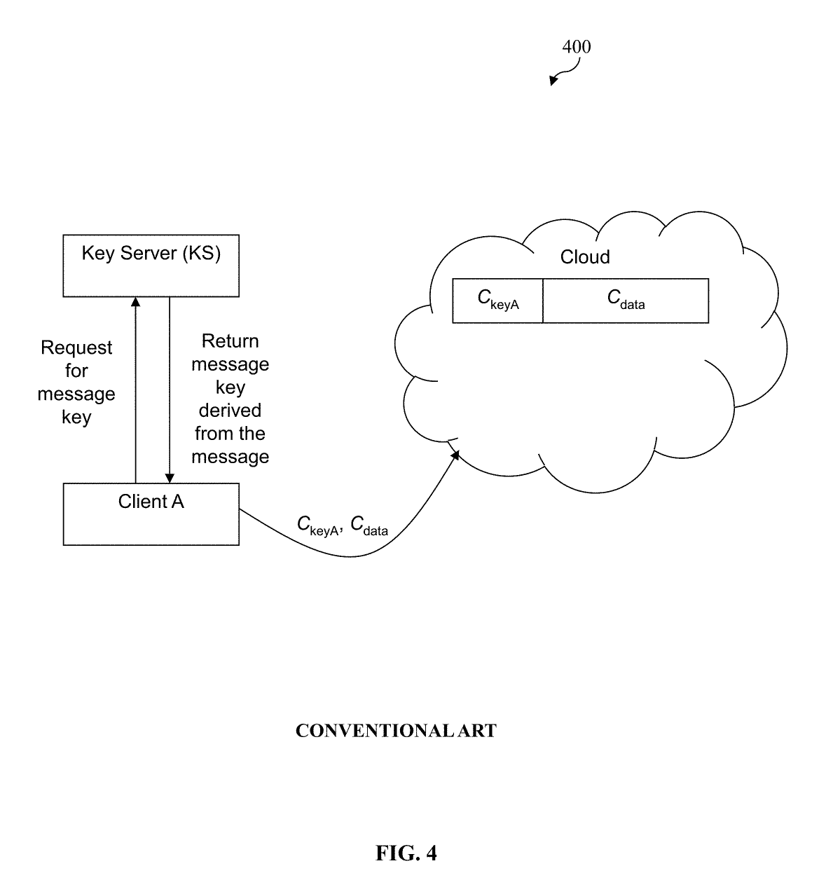

The conventional DupLESS technique as described in Bellare et al., “DupLESS: Server-aided encryption for deduplicated storage,” USENIX Security Symposium, 2013 was developed as an improvement to the CE technique. In DupLESS, the users (i.e., client devices) encrypt their message with the aid of a KS that is separate from the CSP (i.e., cloud storage system, such as, managed by CSP). The KS serves as a semi-trusted third party which will aid in performing dedupable encryption. Users communicate with the KS through an oblivious pseudorandom function (OPRF) protocol, based on RSA blind signatures. At the end of the protocol, users obtain a message-dependent key K derived from the KS's secret key. The benefit of the OPRF protocol is that users learn nothing about the KS's secret key, and the KS learns nothing about the message. Next, the user (i.e., client device) encrypts the message M with K to obtain C_{data}, i.e., C_{data}←E(K,M). The user, say Alice, (e.g., client device A) next encrypts K using her own secret key sk to obtain C_{key A}←E(sk,K). Both encryptions are performed using the Advanced Encryption Standard (AES). Both C_{data} and C_{key A} are sent and stored on the CSP. At a later point in time, suppose another user, say Bob, (e.g., client device B) also wishes to upload the same message M to the CSP, client device B will request for the key from the KS and correspondingly obtain the same K. As such, client device B will generate C_{data} and C_{key B} which is sent over to the CSP. Recognizing that C_{data} has already been uploaded earlier, the CSP can discard this copy and deduplication is achieved. However, C_{key B} needs to be stored in the CSP for retrieval by client device B when Bob wishes to download the file. FIG. 4 depicts a schematic drawing illustrating the conventional DupLESS technique 400 for a data upload.

While the conventional DupLESS technique 400 provides a higher level of security over conventional CE techniques, there are a number of drawbacks in the technique. Firstly, the ciphertexts leak plaintext equality. This means that for an attacker observing the traffic between the client and the CSP, if the attacker observes the same ciphertext being uploaded twice, the attacker can infer that they belong to the same plaintext. This is because the conventional DupLESS technique employs a deterministic encryption technique. Secondly, the ciphertexts leak access patterns for the same reason. For an attacker observing the traffic between the client and the CSP, the attacker can observe the frequency upon which a particular file is uploaded or downloaded by a user. Thirdly, the ciphertexts leak file lengths. This occurs because an encryption of the entire contents of the file is sent over to the CSP. Since the initialization vector (IV) in AES is 16 bytes long, an attacker can deduce the file length simply by taking the length of C_{data} and minus away 16 bytes. In this regard, the encrypted data deduplication techniques according to various embodiments of the present invention can remedy or prevent the plaintext equality and access patterns leakage problems of the conventional DupLESS technique, as well as at least mitigating the file length leakage problem. As such, the encrypted data deduplication techniques according to various embodiments of the present invention advantageously offer a higher level of security over the conventional DupLESS technique.

As described hereinbefore, a further problem of the conventional DupLESS technique is that regardless of whether the same file exists in the CSP or not, the entire encrypted file desired to be stored in the CSP is nevertheless sent to the CSP. It is left to the CSP to perform deduplication within the CSP for identical/duplicate files in an offline process/manner. In the data deduplication techniques according to various embodiments of the present invention, deduplication can be performed online (i.e., based on interactions/communications between the client device and the CSP), using a file identifier. As described hereinbefore, the file identifier is protected using the SWHE technique, thus preventing leakage of access patterns and equality of underlying plaintexts. Also, depending on the hash function used, the length of the file identifier is fixed, regardless of the length of the file. This results in an attacker not being able to infer anything about file length from the file identifier.

Data deduplication techniques (or methods of storing data in a cloud storage system) based on the DupLESS technique (which may be referred to as modified DupLESS techniques) according to various example embodiments of the present invention will be described below as examples only to illustrate how the data deduplication techniques according to various embodiments of the present invention are able to provide data deduplication with improved data security. It will be appreciated to the skilled person that it is not necessary for the data deduplication techniques according to various embodiments of the present invention to be implemented in or based on the DupLESS technique, and that the same (or similar) or corresponding modifications may be made to other data deduplication techniques employing the use of a KS generating a unique message key for the file desired to be uploaded to the CSP as appropriate/desired for various purposes without departing from the scope of the present invention.

In a first embodiment of the present invention, encrypting the file identifier comprises encrypting each bit of the file identifier using a homomorphic encryption technique to obtain an encrypted file identifier comprising a plurality of cipertexts. Furthermore, determining whether the stored data file exists in the cloud storage system that is a duplicate of the data file desired to be stored in the cloud storage system comprises a step of comparing the encrypted file identifier with a file identifier stored in the cloud storage system to obtain a result (the file identifier stored in the cloud storage system corresponding to a data file stored in the cloud storage system), a step of decrypting each bit of the result to obtain a decrypted result, and a step of determining that the stored data file exists in the cloud storage system if each bit of the decrypted result is of a predetermined value. The step of comparing the encrypted file identifier may compare the encrypted file identifier with each file identifier stored in the cloud storage system, respectively, to obtain a respective result.

In the first embodiment, the step of encrypting the file identifier is performed at a client device 210 instructed to store the data file in the cloud storage system 220, the step of comparing the encrypted file identifier is performed at the cloud storage system 220, the step of decrypting each bit of the result is performed at the client device 210, and the step of determining that the stored data file exists in the cloud storage system 220 is performed at the client device 210.

Furthermore, in the first embodiment, the step of comparing the encrypted file identifier may comprise computing a difference between the encrypted file identifier and the file identifier stored in the cloud storage system, the file identifier stored in the cloud storage system being encrypted.

For a better understanding, a first exemplary implementation of the data deduplication technique of the first embodiment of the present invention will now be described below with reference to the flow diagram 500 shown in FIG. 5 by way of an example only and without limitation. The flow diagram 500 illustrates the method of storing or uploading data in a cloud storage system by a user, say Alice.

In the first exemplary implementation, the SWHE technique is used to protect the data deduplication technique against various data security threats. As shown in FIG. 5, when Alice (e.g., client device A) wishes or requests to upload a file Mᵢ to the CSP (i.e., the cloud storage system, such as, managed by the CSP), client device A will proceed to request a message-dependent key Kᵢ from the KS. After receiving Kᵢ from the KS, client device A encrypts Mᵢ using Kᵢ to obtain C_{data,i}. Client device A also encrypts Kᵢ using its own secret key to obtain C_{key A,i}. Then, client device A hashes C_{data,i} to obtain hᵢ←H(C_{data,i}), which acts as or constitutes a file identifier for the file Mᵢ. For a specific file M, the file identifier is unique because H(•) is a collision-resistant hash function. For example, by using the SHA256 hash function, hᵢ will be 256-bits long.

Subsequently, client device A encrypts each of the bits of hᵢ using the SWHE technique. If each of these bits of hᵢ is denoted as hᵢⱼ, where j takes values 0, 1, . . . , 255, then Cᵢⱼ←Encrypt(p, hᵢⱼ) can be obtained. Client device A then sends the vector Cⱼ=[Cᵢ₀, Cᵢ₁, . . . , Cᵢ₂₅₅] (encrypted file identifier) over to the CSP as a query.

The CSP receives Cᵢ and subtracts it from a database of file identifiers (e.g., encrypted file identifiers, each uniquely corresponding to a data file stored in the CSP). Let the number of file identifiers existing in the CSP be denoted as N and each of these file identifiers be denoted as Cₙ, where n takes values 0, 1, . . . , N−1. The CSP (e.g., the cloud storage server 222) computes Cⱼ−Cₙ, and subsequently sends the result back over the network to client device A. Client device A decrypts each of these bits to obtain Decrypt(p, Cᵢⱼ−Cₙⱼ)=hᵢⱼ−hₙⱼ. In this regard, if i=n, then Decrypt(p, Cᵢⱼ−Cₙⱼ)=0 (predetermined value) for j from 0 to 255. As such, if client device A obtains an all-zeros vector as the decrypted result, client device A learns or determines that the CSP already contains the same file. Client device A will then not upload the file originally requested to be uploaded to the CSP, and thus data deduplication with respect to the CSP is performed. To ensure successful download and decryption, client device A may still send its key C_{keyA,i} to the CSP for retrieval later. The above-described first exemplary implementation of the data deduplication technique according to the first embodiment of the present invention may be referred to as the KS_SWHE technique.

Accordingly, as shown in FIG. 5, depending on whether the file identifier already exists in the CSP or not, Alice will either send C_{keyA,i} only or both C_{keyA,i} and C_{data,i}. In addition, the file identifier database need not be updated in the former case, whereas the database is updated with the encrypted file identifier of C_{data,i} in the latter case.

However, the data deduplication technique described above according to the first embodiment may have a potential security issue in that Alice (client device A) will be able to learn all the hash indexes that exist on the CSP. This is because since client device A knows hᵢⱼ, client device A can compute hᵢⱼ−Decrypt(p, Cᵢⱼ−Cₙⱼ) to learn the file identifier bit by bit. After learning H(C_{data,i}), client device A may then be able to obtain C_{data,i} through a brute-force approach. At this point, client device A is still unable to obtain the plaintext as the encryption scheme is semantically secure. However, what client device A can do at this point, is that when other client devices send their queries to the CSP, client device A can intercept the queries and learn whether the files associated with the queries exist in the CSP or not. An improved data deduplication technique according to a second embodiment of the present invention will now be described to address such a possible security issue (e.g., whereby client device A will be unable to derive the above-mentioned knowledge in the above described manner).

In the second embodiment, similarly, encrypting the file identifier comprises encrypting each bit of the file identifier using the homomorphic encryption technique to obtain the encrypted file identifier comprising a plurality of cipertexts. However, determining whether the stored data file exists in the cloud storage system that is a duplicate of the data file desired to be stored in the cloud storage system comprises computing a function based on the encrypted file identifier and a file identifier stored in the cloud storage system to obtain a result, the file identifier stored in the cloud storage system corresponding to a data file stored in the cloud storage system, decrypting the result to obtain a decrypted result, and determining whether the stored data file exists in the cloud storage system based on whether the decrypted result is of a predetermined value.

In the second embodiment, the function may configured such that the decrypted result will be the predetermined value if and only if each bit of the encrypted file identifier matches with each corresponding bit of said file identifier stored in the cloud storage system. More specifically, the function/equation may be expressed as:

$${D}_{i , n} = {\prod }_{j = 0}^{J - 1} ( 1 + {C}_{ij} + {C}_{nj} ) \qquad ( Equation 1 )$$

where:

D_{i,n} denotes the result obtained for the encrypted file identifier of the i-th data file desired to be stored in the cloud storage system and the n-th file identifier stored in the cloud storage system;

Cᵢⱼ denotes the j-th bit of the encrypted file identifier of the i-th data file;

Cₙⱼ denotes the j-th bit of the n-th file identifier stored in the cloud storage system; and

J denotes a window size based on the number of bits of the encrypted file identifier of the i-th data file.

In the second embodiment, the window size of the function may be determined based on a security parameter (λ) associated with the homomorphic encryption technique. Furthermore, the step of encrypting the file identifier is performed at a client device instructed to store the data file desired in the cloud storage system, the step of computing a function is performed at the cloud storage system, the step of decrypting the result is performed at the client device, and the step of determining that the stored data file exists in the cloud storage system is performed at the client device.

For a better understanding, a second exemplary implementation of the data deduplication technique according to the second embodiment of the present invention will now be described below by way of an example only and without limitation.

In the second exemplary implementation, a technique is developed such that Alice (client device A) is able to learn if a particular file identifier exists in the CSP (i.e., the cloud storage system, such as, managed by the CSP) or not, without learning all the file identifiers stored in the cloud. As with the first exemplary implementation, client device A computes Cᵢⱼ←Encrypt(p, hᵢⱼ) and sends the vector Cᵢ=[Cᵢ₀, C_{i,1}, . . . , Cᵢ₂₅₅] (encrypted file identifier) over to the CSP as a query. However, in the second exemplary implementation, the CSP computes the following function/equation (Equation 1):

$${D}_{i , n} = {\prod }_{j = 0}^{J - 1} ( 1 + {C}_{ij} + {C}_{nj} ) ,$$

and sends the result D_{i,n} back to client device A. Client device A then decrypts the result and Decrypt(p, D_{i,n}) will return 1 (predetermined value) if and only if hᵢⱼ=hₙⱼ for all values of j. In the above function, J denotes the window size, and it is determined according to embodiments of the present invention to ensure decryption correctness. If the decrypted result is 1 for all the windows within the number of bits of the file identifier (256-bit string in the example), it is determined that the same file already exists on the CSP.

As an example illustration of how the second exemplary implementation will work for string matching, consider a 2-bit string hᵢ=[mᵢ₀, mᵢ₁] and hₙ=[mₙ₀, mₙ₁]. After encryption, Cᵢ=[pqᵢ₀+2rᵢ₀+mᵢ₀, pqᵢ₁+2rᵢ₁+mᵢ₁] and C=[pqₙ₀+2rₙ₀+mₙ₀+2rₙ₀+mₙ₀, pqₙ₁+2rₙ₁+mₙ₁] is obtained. Using the above-mentioned function, the following result is obtained:

D_{i,n}=(1+pqᵢ₀+2rᵢ₀+mᵢ₀+pqₙ₀+2rₙ₀+mₙ₀)(1+pqᵢ₁+2r+mᵢ₁+pqₙ₁+2rₙ₁+mₙ₁)

Decrypting the result D_{i,n}, the following is obtained:

[D_{i,n} mod p mod 2]=[(mᵢ₀+mₙ₀+1)(mᵢ₁+mₙ₁+1)mod 2],

as long as the noise term is within (−p/2, +p/2]. It can be verified or deduced that the above returns 1 if and only if mᵢ₀=mₙ₀ and mᵢ₁=mₙ₁, and holds true in general for strings of arbitrary length.

A method of selecting or determining an appropriate window size J to ensure decryption correctness will now be described according to an example embodiment of the present invention. For the computed ciphertext to decrypt correctly, it is necessary to ensure that its noise term is less than or equal to p/2, that is,

$${\prod }_{j = 0}^{J - 1} ( 1 + 2 {r}_{0 j} + {m}_{0 j} + 2 {r}_{1 j} + {m}_{1 j} ) \leq p / 2 \qquad ( Equation 2 )$$

As r has λ bits, the term 2r has at most (λ+1) bits, and as 2r is even, 2r+m has at most (λ+1) bits. If the two k-bit numbers are added, the result will be at most a (k+1)-bit number. Therefore, the term (1+2r₀ⱼ+m₀ⱼ+2r₁ⱼ+mᵢⱼ) has at most (λ+3) bits. If a k₁-bit number is multiplied with a k₂-bit number, the result will be approximately a (k₁+k₂)-bit number. In other words, the left-hand side of the equation above will have at most J(λ+3) bits. Therefore, the above equation can be expressed as:

$${\prod }_{j = 0}^{J - 1} ( 1 + 2 {r}_{0 j} + {m}_{0 j} + 2 {r}_{1 j} + {m}_{1 j} ) < {2}^{J ( λ + 3 )} \leq p / 2 \qquad ( Equation 3 )$$

Furthermore, asp has λ²-bits, this means that:

p/2≧2^{λ}^{²}⁻¹/2=2^{λ}^{²}⁻² (Equation 4)

Therefore, to meet Equation (2), it is sufficient to solve

2^{J(λ3)}≦2^{λ}^{²}⁻², (Equation 4)

which results in:

$$J \leq \frac{{λ}^{2} - 2}{λ + 3} \qquad ( Equation 5 )$$

Accordingly, for example, if λ=42, J can be set as 39. If λ=72, J can be set as 69.

Having determined a value for J, Alice (client device A) may be able to determine whether the same file already exists in the CSP as follows. Client device A computes Cᵢⱼ←Encrypt(p, kᵢⱼ) and sends the vector Cᵢ=[Cᵢ₀, Cᵢ₁, . . . , Cᵢ₂₅₅] (encrypted file identifier) over to the CSP as a query. The CSP may then compute D_{i,n} and send the result back to client device A. Client device A then decrypts and Decrypt(p, will return 1 if and only if hᵢⱼ=hₙⱼ for all values of j from 0 to J−1. As such, if hᵢⱼ=hₙⱼ for j from 0 to 255 (in the example where hᵢ is 256-bits long), client device A learns or determines that the CSP already contains the file. Client device A may then not upload the file desired to be stored in the CSP, and thus data deduplication with respect to the CSP is performed. To ensure successful download and decryption, client device A may still send her key C_{keyA,i} to the CSP for retrieval later. The second exemplary implementation of the data deduplication technique according to the second embodiment of the present invention may be referred to as the KS_SWHE_StrMatch technique.

Another data deduplication technique according to a third embodiment of the present invention will now be described. In the third embodiment, encrypting the file identifier comprises encrypting the file identifier using the homomorphic encryption technique to obtain a cipertext constituting the encrypted file identifier. Furthermore, determining whether the stored data file exists in the in the cloud storage system that is a duplicate of the data file desired to be stored in the cloud storage system comprises a step of comparing the encrypted file identifier with a file identifier stored in the cloud storage system to obtain a result, the file identifier stored in the cloud storage system corresponding to a data file stored in the cloud storage system, a step of decrypting the result to obtain a decrypted result, and a step of determining that the stored data file exists in the cloud storage system if the decrypted result is of a predetermined value. The step of comparing the encrypted file identifier may compare the encrypted file identifier with each file identifier stored in the cloud storage system, respectively, to obtain a respective result.

In the third embodiment, the step of encrypting the file identifier is performed at a client device instructed to store the data file in the cloud storage system, the step of comparing the encrypted file identifier is performed at the cloud storage system, the step of decrypting each bit of the result is performed at the client device, and the step of determining that the stored data file exists in the cloud storage system is performed at the client device.

Furthermore, in the third embodiment, the step of comparing the encrypted file identifier may comprise computing a difference between the encrypted file identifier and the file identifier stored in the cloud storage system, the file identifier stored in the cloud storage system being encrypted.

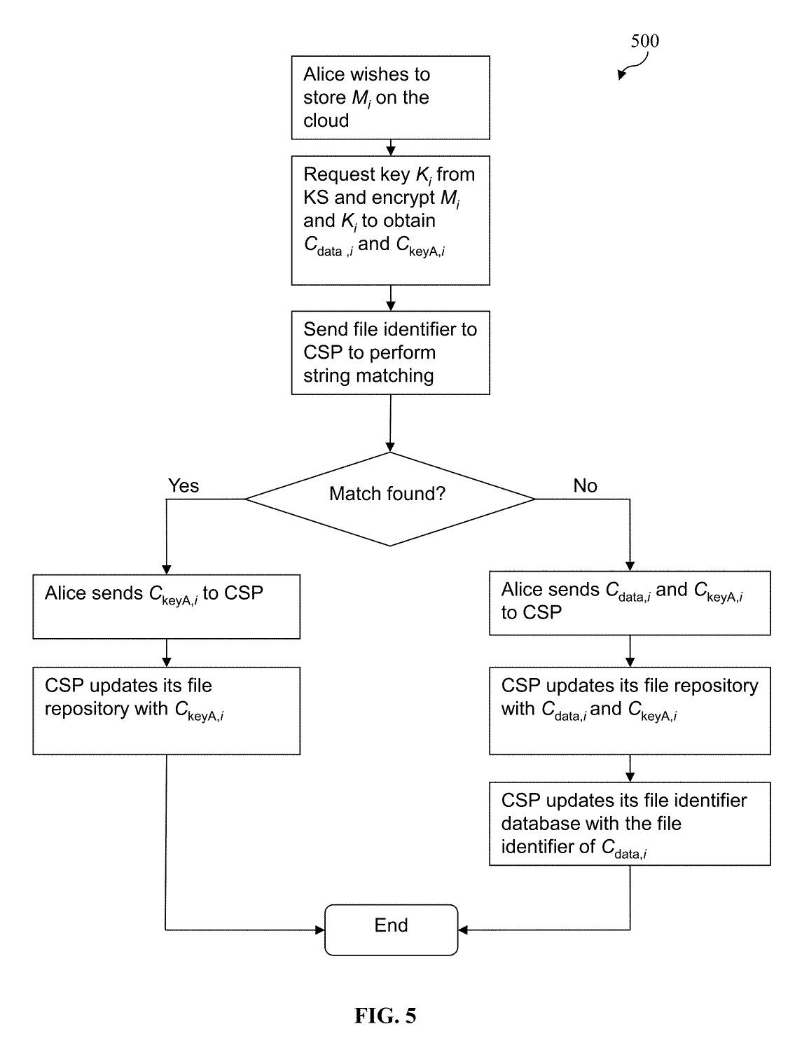

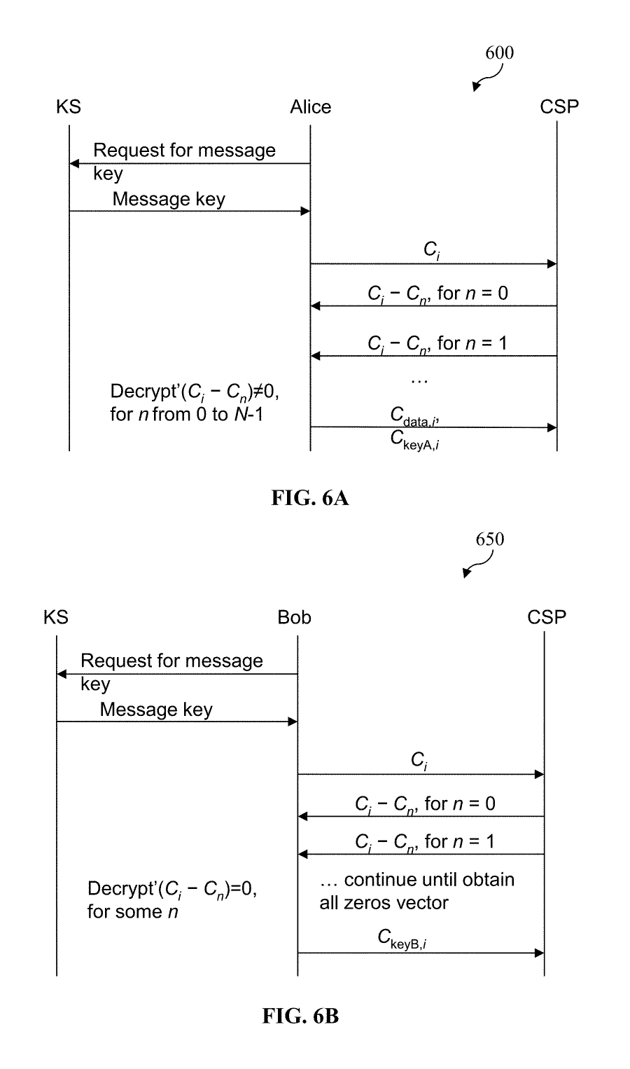

For a better understanding, a third exemplary implementation of the data deduplication technique according to the third embodiment of the present invention will now be described below with reference to the flow diagrams 600, 650 as shown in FIGS. 6A and 6B by way of an example only and without limitation.

The third exemplary implementation is configured to compare two strings using SWHE. In the third exemplary implementation, the plaintext is considered as a large number instead of a binary string, and the large number is denoted as mᵢ, which is the equivalent of hᵢ in base 10 notation. The CSP also has a database of file identifiers, denoted as mₙ, for n=0 to N−1. Suppose both mᵢ and mₙ are bₘ-bits long, the following is known:

−2^{b}^{ₘ}<mᵢ−mₙ<2^{b}^{ₘ}.

Given this prior knowledge, the encryption technique can be modified as follows: denote λ as the security parameter, and set N=λ, P=λ², and Q=λ⁵. The SWHE technique in the third exemplary implementation may be described as including the following three algorithms:

KeyGen′(λ): The secret key, denoted as p, is an odd integer chosen randomly from the interval [2^{P-1}, 2^{P});

Encrypt′(p, m): To encrypt a non-binary message m with bₘ-bits, set c←pq+2tr+m, where q is an integer chosen randomly from the interval [0, 2^{Q}), and r is an integer chosen randomly from the interval (−2^{N}, 2^{N}). Here, set t=2^{b}^{ₘ}; and

Decrypt′(p, c): Output (c mod p) mod 2t, where (c mod p) is the integer c′ in (−p/2, p/2] such that p divides c-c′. The decryption returns a result in the range (−t, t], which is desirable.

Next, the parameter bₘ may be determined or chosen appropriately so as to ensure the noise of the computed ciphertext remains in the range (p/2, p/2], that is:

(2trᵢ+m₁)−(2tr₂+m₂)≦p/2. (Equation 6)

As r has λ bits, the term 2r has at most (λ+1) bits. It is also known that t=2^{b}^{ₘ} has (bₘ+1) bits, so 2tr has at most (λ+bₘ+2)-bits. Further, 2tr+m will have at most (λ+bₘ+3)-bits. Therefore, the following equation can be obtain:

(2tr₁+m₁)−(2tr₂+m₂)<2^{λ+b}^{ₘ}⁺³≦p/2. (Equation 7)

Furthermore, as p has λ²-bits, this means that:

p/2≧2^{λ}^{²}⁻¹/2=^{λ}^{²}⁻². (Equation 8)

Therefore, to meet the above Equation (6), it is sufficient to solve:

2^{λ+b}^{ₘ}⁺³≦2^{λ}^{²}⁻², (Equation 9)

which results in:

bₘ≦λ²−λ−5. (Equation 10)

Accordingly, for example, if λ=42, bₘ≦1717 is required, and if λ=72, bₘ≦5107 is required. In various embodiments of the present invention, a hash length of 256-bits for the encrypted file identifier is used, which therefore fits the requirement of bₘ≦1717 when λ=42 or more.

Having determined suitable values for bₘ, Alice (client device A) may determine whether the same file already exists in the CSP as follows. The number of file identifiers existing in the CSP is denoted as N and each of these file identifiers are denoted as Cₙ, where n takes values 0, 1, . . . , N−1. Client device A computes Cᵢ←Encrypt(p, mᵢ) and sends Cᵢ (encrypted file identifier) over to the CSP as a query. The CSP may then compute Cᵢ−Cₙ and send the result back to client device A. Client device A decrypts the result (Decrypt(p, Cᵢ−Cₙ)) and the result will return 0 if and only if mᵢ=mₙ or hᵢ=hₙ. As such, if hᵢ=hₙ, client device A learns or determines that the CSP already contains the file. Client device A will then not upload the file desired to be stored in the CSP, and thus deduplication is performed. To ensure successful download and decryption, client device A may still send its key C_{keyA,i} to the CSP for retrieval later. The third exemplary implementation of the data deduplication technique according to the third embodiment of the present invention may be referred to as the KS_SWHE_LargeMsg technique.

FIG. 6A depicts a flow diagram showing a summary of the third exemplary implementation of the data deduplication technique for the first upload of a file by Alice (first client device or client device A). In this case, the same file does not yet exist on the cloud. As such, client device A computes Decrypt′(p, Cᵢ−Cₙ) for n from 0 to N−1, where Cᵢ←Encrypt′(p, mᵢ) and Cₙ←Encrypt′(p, mₙ). If the result does not return 0 for all values of n, client device A determines that the same file does not yet exist in the CSP. Subsequently, client device A sends C_{data,j} and C_{keyA,i} over to the CSP for storage.

FIG. 6B depicts a flow diagram showing a summary of the third exemplary implementation of the data deduplication technique for a subsequent upload of a file by Bob (second client device or client device B). In this case, Bob wishes to upload a file that already exists on the CSP. The CSP sends to client device B the result of Cᵢ−Cₙ for n starting from 0, 1, . . . until N−1 or until client device B decrypts and obtains a 0 (zero). In this regard, obtaining a zero means that the same file already exists in the CSP, and thus client device B does not send C_{data,i} (encrypted data file described to be stored in the CSP) to the CSP, but may still send C_{keyB,i} for storage in the CSP.

An advantage of the data deduplication technique according to the third embodiment (e.g., KS_SWHE_LargeMsg technique) is that, since the entire file identifier is encrypted into one ciphertext, the technique is significantly faster than the first and second embodiments (e.g., KS_SWHE and KS_SWHE_StrMatch techniques) where bit-by-bit encryption may be required. Further, in the third embodiment, for one file identifier only one ciphertext is required to be stored in the file identifier database of the cloud storage system. In contrast, for the first and second embodiments, 256 ciphertexts may be required to be stored for one file identifier. Therefore, the third embodiment may result in significant time and storage savings over the first and second embodiments of data deduplication techniques described hereinbefore.

The security of the SWHE technique as described hereinabove according to various embodiments of the present invention may be examined based on the approximate greatest common divisor (GCD) problem. The approximate GCD problem may be expressed as follows: given x₁=s₁+pq₁, and x₂=s₂+pq₂, with s₁ and s₂ much smaller than p, find p in polynomial time. However, the approximate GCD problem is a hard or impossible problem to solve. It can be deduced that if one is able to solve the approximate GCD problem, one is able to break the SWHE technique described hereinbefore. Therefore, since solving the approximate GCD problem is hard or impossible, breaking the SWHE technique described hereinbefore is also hard or impossible. As such, the SWHE technique employed in the data deduplication techniques according to various embodiments of the present invention is provably secure.

As described hereinbefore, implementing SWHE with the DupLESS technique as an example may successfully remove leakage of plaintext equality and access patterns. SWHE is able to achieve this because random numbers q, r are used in the encryption technique. Due to the random numbers, an attacker observing the traffic between the client device and the CSP will not be able to infer that the queries (in this case, Cⱼ or Cᵢ depending on the technique used) belong to the same plaintext. As such, there is no leakage of access patterns and plaintext equality. Further, if the same file already exists on the CSP, C_{data} is not sent over to the CSP. This results in an attacker observing the traffic not being able to obtain the file length of the original file desired to be stored on the CSP. As such, the data deduplication techniques according to various embodiments of the present invention is also able to mitigate the file length leakage problem. Although the client device may still need to send C_{key} to the CSP, C_{key} is of a fixed length and reveals nothing about the length or the contents of the original file.

Various experiments were performed based on the exemplary implementations described above to compare the performance overhead of the data deduplication techniques according to various embodiments of the present invention with the conventional DupLESS technique. In the experiments, Dropbox was used as the CSP, and the Dropbox Core API was used to upload and download files. Running times were measured using the timeit Python module. In the experiments, different files with random contents of size 4 MB to 128 MB were investigated. The experiments were performed on a desktop machine with Intel Xeon CPU running at 2.2 GHz and 8 GB of memory and using Ethernet cable connection. In all the plots shown in FIGS. 7 to 10 to be described below, each data point was obtained by taking the average of 10 experiments. Furthermore, in the experiments, security parameter λ=42 was used as a proof of concept. Although this provides only a trivial level of security, but it allows for easier implementation for illustration purposes due to memory constraints.

In the experiments, it was found that to upload a file for the first time, large overheads were incurred for the KS_SWHE and KS_SWHE_StrMatch techniques. To encrypt a single bit H(C_{data,i}) and write to the file identifier database was found to take around 65 seconds. Given that there are 256 bits in the hash index, the whole upload process was found to take around 4 hours. Therefore, for the purpose of performance evaluation, only the results of the KS_SWHE_LargeMsg technique are provided herein below for simplicity.

FIG. 7 depicts a plot 700 showing the performance results in uploading a file for the first time using the KS_SWHE_LargeMsg technique and the conventional KS (baseline) technique. It was assumed that there were no prior files existing in the CSP at this point. The KS (baseline) technique shown in FIG. 7 refers to the conventional DupLESS technique, which was used the baseline for performance evaluation. The latency overhead for the KS_SWHE_LargeMsg technique shown in FIG. 7 was due to the requirement to encrypt H(C_{data}) using the SWHE for non-binary messages technique, checking for a match on the CSP, and updating the file identifier database for the first upload. It can be observed that for file sizes of 4 MB and 64 MB, the latency overhead of the KS_SWHE technique is 481% and 78%, respectively. However, as the file size increased to 128 MB, the latency overhead reduced to 63%. This is because as the file size increases, a larger percentage of the execution time is spent on uploading the large file over the network. Therefore, it can be observed that the encryption technique adds only a smaller percentage to the whole execution time, as the file size increases. Accordingly, the latency overhead can be expected to be even more insignificant as the file size increases further. In FIG. 7, the timing result for uploading a file without any encryption (“no encryption”) is also shown for reference.

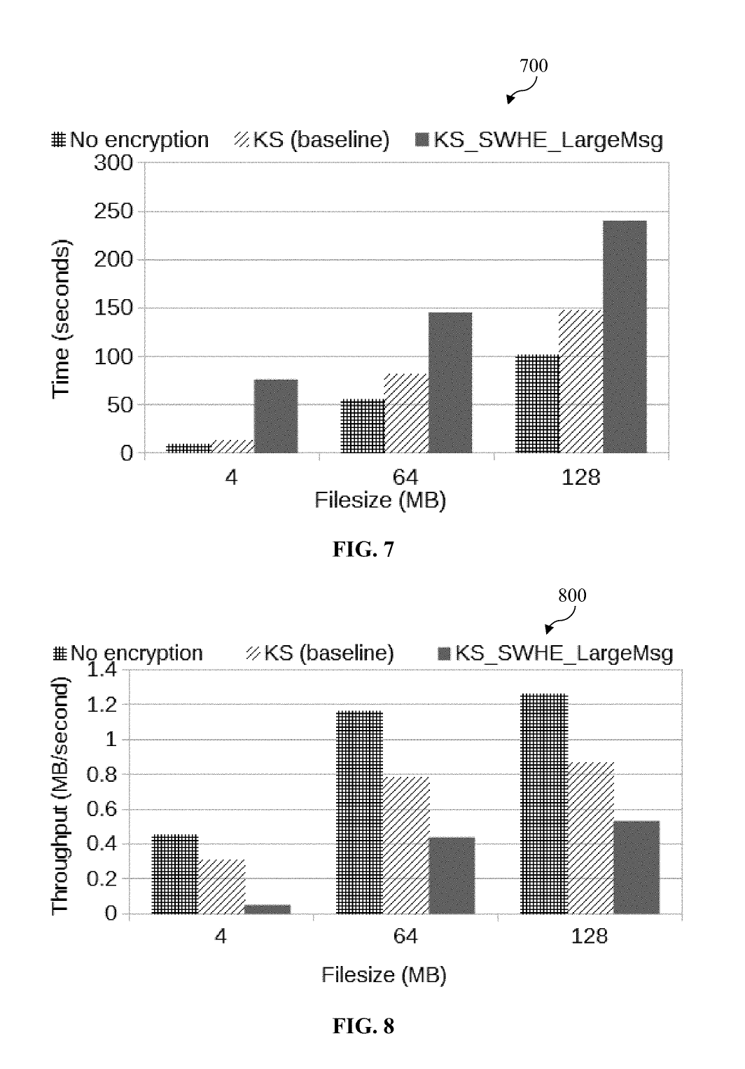

FIG. 8 depicts a plot 800 showing the throughput results in uploading a file for the first time using the KS_SWHE_LargeMsg technique and the conventional KS (baseline) technique. Inevitably, the KS_SWHE_LargeMsg technique suffers a drop in throughput compared to the KS (baseline) technique. However, it is observed that this percentage drop in throughput performance decreases as file size increases from 4 MB to 64 MB. This demonstrates that the decrease in throughput performance will decrease and become negligible as the file size increases. In FIG. 8, the throughput for uploading a file without any encryption (“no encryption”) is also shown for reference.

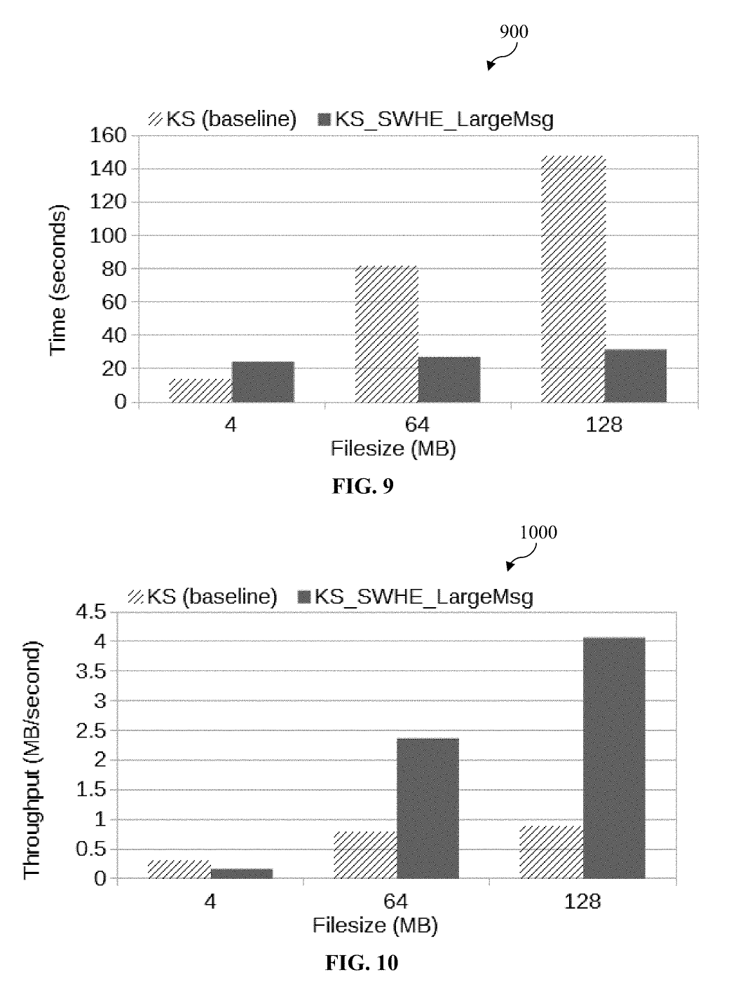

FIG. 9 depicts a plot 900 showing the results in uploading a file for the i^{th} time, where i≧2, using the KS_SWHE_LargeMsg technique and the conventional KS (baseline) technique. It was assumed that only a single file (that is, the first file uploaded as described above) exists in the CSP at this point. In the KS_SWHE_LargeMsg technique, prior to uploading of C_{data}, the hash of C_{data} was sent to as a query to the CSP to determine whether the same file exists in the CSP or not. If the same file exists, C_{data} is not sent to the CSP, thus resulting in substantial time and bandwidth savings. This is unlike the conventional DupLESS technique where C_{data} is sent over the network regardless of whether the same file exists in the CSP. However, for file size of 4 MB, even though only the file identifier was sent and not the entire file to query the CSP, the KS_SWHE_LargeMsg technique does not appear to achieve latency reduction over the conventional KS technique. This is because the encryption and database update process take a significant amount of time. From FIG. 9, it can be observed that only when the file size increases to 64 MB and 128 MB that the superior performance of the KS_SWHE_LargeMsg technique over the conventional KS technique is more evident or significant. As the file size increases, based on the above observation, the latency reduction can be expected to be even more significant.

FIG. 10 depicts a plot 1000 showing the throughput results in uploading a file for the i^{th} time, where i≧2, using the KS_SWHE_LargeMsg technique and the conventional KS (baseline) technique. It can be seen that the KS_SWHE_LargeMsg technique achieves a significant improvement in throughout for larger file sizes of 64 and 128 MB. As the file size increases, based on the above observation, the throughput improvement can be expected to be even more significant.

Accordingly, based on the results shown in FIGS. 7 to 10, it can be observed that the KS_SWHE_LargeMsg technique as an exemplary implementation of the data deduplication technique according to embodiments of the present invention may incur latency overhead for the first upload. However, this latency overhead decreases as the file size increases. Furthermore, for subsequent uploads, significant latency reduction can be achieved compared to the conventional KS technique.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of storing data in a cloud storage system, the method comprising:
generating a file identifier for a data file desired to be stored in the cloud storage system;
encrypting the file identifier of the data file using a homomorphic encryption technique to produce an encrypted file identifier of the data file; and
transmitting the encrypted file identifier to the cloud storage system for performing data deduplication in relation to the cloud storage system with respect to the data file.

2. The method according to claim 1, wherein the file identifier is generated based on a hash function of the data file such that the file identifier generated is unique to the data file.

3. The method according to claim 1, further comprising encrypting the data file based on a key generated by a key server to produce an encrypted data file, wherein the file identifier is generated based on the encrypted data file.

4. The method according to claim 1, wherein performing data deduplication comprises:
determining whether a stored data file exists in the cloud storage system that is a duplicate of the data file desired to be stored in the cloud storage system based on the encrypted file identifier of the data file; and
determining whether to transmit the data file to the cloud storage system for storage therein based on whether said stored data file is determined to exist in the cloud storage system.

5. The method according to claim 4, wherein:
encrypting the file identifier comprises encrypting each bit of the file identifier using the homomorphic encryption technique to obtain the encrypted file identifier comprising a plurality of cipertexts; and
determining whether the stored data file exists in the cloud storage system that is a duplicate of the data file desired to be stored in the cloud storage system comprises:
comparing the encrypted file identifier with a file identifier stored in the cloud storage system to obtain a result, the file identifier stored in the cloud storage system corresponding to a data file stored in the cloud storage system;
decrypting each bit of the result to obtain a decrypted result; and
determining that the stored data file exists in the cloud storage system if each bit of the decrypted result is of a predetermined value.

6. The method according to claim 5, wherein said comparing the encrypted file identifier compares the encrypted file identifier with each file identifier stored in the cloud storage system, respectively, to obtain a respective result.

7. The method according to claim 5, wherein:
said encrypting the file identifier is performed at a client device instructed to store the data file in the cloud storage system;
said comparing the encrypted file identifier is performed at the cloud storage system;
said decrypting each bit of the result is performed at the client device; and
said determining that the stored data file exists in the cloud storage system is performed at the client device.

8. The method according to claim 5, wherein said comparing the encrypted file identifier comprises computing a difference between the encrypted file identifier and said file identifier stored in the cloud storage system, said file identifier stored in the cloud storage system being encrypted.

9. The method according to claim 4, wherein:
encrypting the file identifier comprises encrypting each bit of the file identifier using the homomorphic encryption technique to obtain the encrypted file identifier comprising a plurality of cipertexts; and
determining whether the stored data file exists in the cloud storage system that is a duplicate of the data file desired to be stored in the cloud storage system comprises:
computing a function based on the encrypted file identifier and a file identifier stored in the cloud storage system to obtain a result, the file identifier stored in the cloud storage system corresponding to a data file stored in the cloud storage system;
decrypting the result to obtain a decrypted result; and
determining whether the stored data file exists in the cloud storage system based on whether the decrypted result is of a predetermined value.

10. The method according to claim 9, wherein the function is configured such that the decrypted result will be the predetermined value if and only if each bit of the encrypted file identifier matches with each corresponding bit of said file identifier stored in the cloud storage system.

11. The method according to claim 10, wherein the function is:
$${D}_{i , n} = {\prod }_{j = 0}^{J - 1} ( 1 + {C}_{ij} + {C}_{nj} )$$
wherein:
D_{i,n} denotes the result obtained for the encrypted file identifier of the i-th data file desired to be stored in the cloud storage system and the n-th file identifier stored in the cloud storage system;
Cᵢⱼ denotes the j-th bit of the encrypted file identifier of the i-th data file;
Cₙⱼ denotes the j-th bit of the n-th file identifier stored in the cloud storage system; and
J denotes a window size based on the number of bits of the encrypted file identifier of the i-th data file.

12. The method according to claim 11, wherein the window size of the function is determined based on a security parameter associated with the homomorphic encryption technique.

13. The method according to claim 9, wherein:
said encrypting the file identifier is performed at a client device instructed to store the data file desired in the cloud storage system;
said computing a function is performed at the cloud storage system;
said decrypting the result is performed at the client device; and
said determining that the stored data file exists in the cloud storage system is performed at the client device.

14. The method according to claim 4, wherein:
encrypting the file identifier comprises encrypting the file identifier using the homomorphic encryption technique to obtain a cipertext constituting the encrypted file identifier; and
determining whether the stored data file exists in the in the cloud storage system that is a duplicate of the data file desired to be stored in the cloud storage system comprises:
comparing the encrypted file identifier with a file identifier stored in the cloud storage system to obtain a result, the file identifier stored in the cloud storage system corresponding to a data file stored in the cloud storage system;
decrypting the result to obtain a decrypted result; and
determining that the stored data file exists in the cloud storage system if the decrypted result is of a predetermined value.

15. The method according to claim 14, wherein said comparing the encrypted file identifier compares the encrypted file identifier with each file identifier stored in the cloud storage system, respectively, to obtain a respective result.

16. The method according to claim 14, wherein:
said encrypting the file identifier is performed at a client device instructed to store the data file in the cloud storage system;
said comparing the encrypted file identifier is performed at the cloud storage system;
said decrypting each bit of the result is performed at the client device; and
said determining that the stored data file exists in the cloud storage system is performed at the client device.

17. The method according to claim 14, wherein said comparing the encrypted file identifier comprises computing a difference between the encrypted file identifier and said file identifier stored in the cloud storage system, said file identifier stored in the cloud storage system being encrypted.

18. The method according to claim 4, wherein the homomorphic encryption technique is a somewhat homomorphic encryption technique.

19. A client device comprising:
a file identifier generation module configured to generate a file identifier for a data file desired to be stored in a cloud storage system;
an encryption module configured to encrypt the file identifier of the data file using a homomorphic encryption technique to produce an encrypted file identifier of the data file; and
a transmitter for transmitting the encrypted file identifier to the cloud storage system for performing data deduplication in relation to the cloud storage system with respect to the data file.

20. A cloud storage system comprising:
a receiver for receiving an encrypted file identifier from a client device for a data file desired to be stored in the cloud storage system; and
a data deduplication module configured to compare the encrypted file identifier with a file identifier stored in the cloud storage system to obtain a result, or to compute a function based on the encrypted file identifier and a file identifier stored in the cloud storage system to obtain a result, for performing data deduplication with respect to the data file based on the result, wherein the file identifier stored in the cloud storage system corresponds to a data file stored in the cloud storage system.
